(19) United States
(12) Patent Application Publication
(10) Pub. No.: US 2013/0200076 A1
(43) Pub. Date: Aug. 8, 2013

(54) TIN LINER

(71) Applicants: Patricia Ann Farruggio, Mosman Park (AU); Edward Joseph Khoury, Bateman (AU)

(72) Inventors: Patricia Ann Farruggio, Mosman Park (AU); Edward Joseph Khoury, Bateman (AU)

(21) Appl. No.: 13/698,762

(22) PCT Filed: May 16, 2011
(86) PCT No.: PCT/AU2011/000571

§ 371 Date: Jan. 31, 2013

(30) Foreign Application Priority Data
May 18, 2010 (AU) 2010902157

(51) Int. Cl. A21B 3/13

(52) U.S. Cl. CPC A21B 3/131
USPC 220/495.03

(57) ABSTRACT

A tin liner including a portion sheet of material having a first longitudinal side and a second longitudinal side and a plurality of transversely extending elongate strips extending from the second longitudinal side. Each elongate strip has first and second parallel longitudinal sides. When the sheet of material is formed into a tube, the elongate strips can be folded perpendicularly to the plane of the sheet such that the elongate strips overlap to form a planar surface bounding an end of the formed tube.

### FIELD OF THE INVENTION

The present invention relates to a tin liner to be used for lining tins such as baking tins.

### BACKGROUND TO THE INVENTION

Baking tins for the baking of cakes and the like generally comprise a cylindrical outer wall and a circular lower wall. A common problem with baking cakes in such tins is that the cake mixture can stick during cooking and become difficult to remove on completion without damaging the outer surface of the cake.

Baking paper is often used to line the baking tin in order to prevent sticking. When using baking tins however, preparing the baking paper to suitably cover the entire inner surface can be difficult. Baking paper is generally provided in rolls from which rectangular sections can be torn off. While a rectangular section can be wrapped around the inner side wall to line a circular tin, a section must be cut by hand to cover the lower wall. Cutting an accurate section of precisely the right size can be difficult. It is therefore common for cake mixture to leak through the gap between the piece on the bottom of the baking tin and the piece lining the side wall.

The present invention relates to a tin liner for baking tins that makes the process of lining the tin easier and results in an adequate seal around the inner surface of the baking tin to prevent leakage of the mixture placed in the tin.

### SUMMARY OF THE INVENTION

According to one aspect of the present invention there is provided a tin liner comprising:

a portion of sheet of material having a first longitudinal side and a second longitudinal side; and

a plurality of transversely extending elongate strips extending from the second longitudinal side, each elongate strip having first and second parallel longitudinal sides;

wherein when the sheet of material is formed into a tube, the elongate strips can be folded perpendicularly to the plane of the sheet such that the elongate strips overlap to form a planar surface bounding an end of the formed tube.

Preferably each elongate strip is provided with a crease extending across the elongate strip adjacent a proximal end in a direction that is at an angle to an axis perpendicular to the elongate strip.

Preferably each crease extends from an inner end of a first longitudinal side of the elongate strip to a point offset away from the inner end of an opposite second longitudinal side of the elongate strip. In one embodiment, the creases are arcuate in shape. Preferably the elongate strips include rounded distal ends.

In a preferred embodiment, the length of the elongate strips is at least 40% of the width of the tin liner from the first side of the portion of the sheet material to the distal ends of the elongate strips. Preferably the length of the elongate strips is 45 to 50% of the width of the tin liner.

In a preferred embodiment, the width of each elongate strip is less than 40% of the length of the elongate strip. Preferably the width of each elongate strip is 25 to 30% of the length of the elongate strip.

Preferably each longitudinal elongate strip is directly adjacent each of the adjacent elongate strips so that no gap exists between adjacent pairs of elongate strips.

The tin liner may be provided on a roll within a dispenser. The dispenser preferably comprises an elongate box having an opening through which a sheet of the tin liner can be pulled and a serrated cutting elongate strip for tearing off segments of the tin liner for use.

In one embodiment, the tin liner includes graduations along the length thereof to provide an indication of the length of tin liner.

In a further embodiment, perforated lines are provided along the length of the tin liner to allow sections to be torn off.

### BRIEF DESCRIPTION OF THE DRAWINGS

The invention will now be described, by way of example, with reference to the following drawings in which:

FIG. 1 is a plan view of a tin liner in accordance with the present invention;

FIG. 2 is view of the tin liner of FIG. 1 and a dispenser for providing the tin liner as a roll;

FIG. 3a is an upper perspective view of the tin liner of FIG. 1 during insertion into a baking tin; and

FIG. 3b is an upper perspective view of the tin liner fully inserted into the baking tin.

### DETAILED DESCRIPTION OF PREFERRED EMBODIMENTS

Referring to the Figures, there is shown a tin liner 10 for use with a circular baking tin 12. The baking tin 12 is of a standard construction comprising a cylindrical side wall 14 and a circular base wall 15. While the embodiment shown will be described with reference to a circular baking tin 12, the tin liner 10 may also be used on square or rectangular tins.

The tin liner 10 comprises an elongate sheet 16 of material. The material preferably comprises a paper based material suitable for use lining a baking tin 12 to prevent a mixture inserted within the baking tin 12 sticking during cooking.

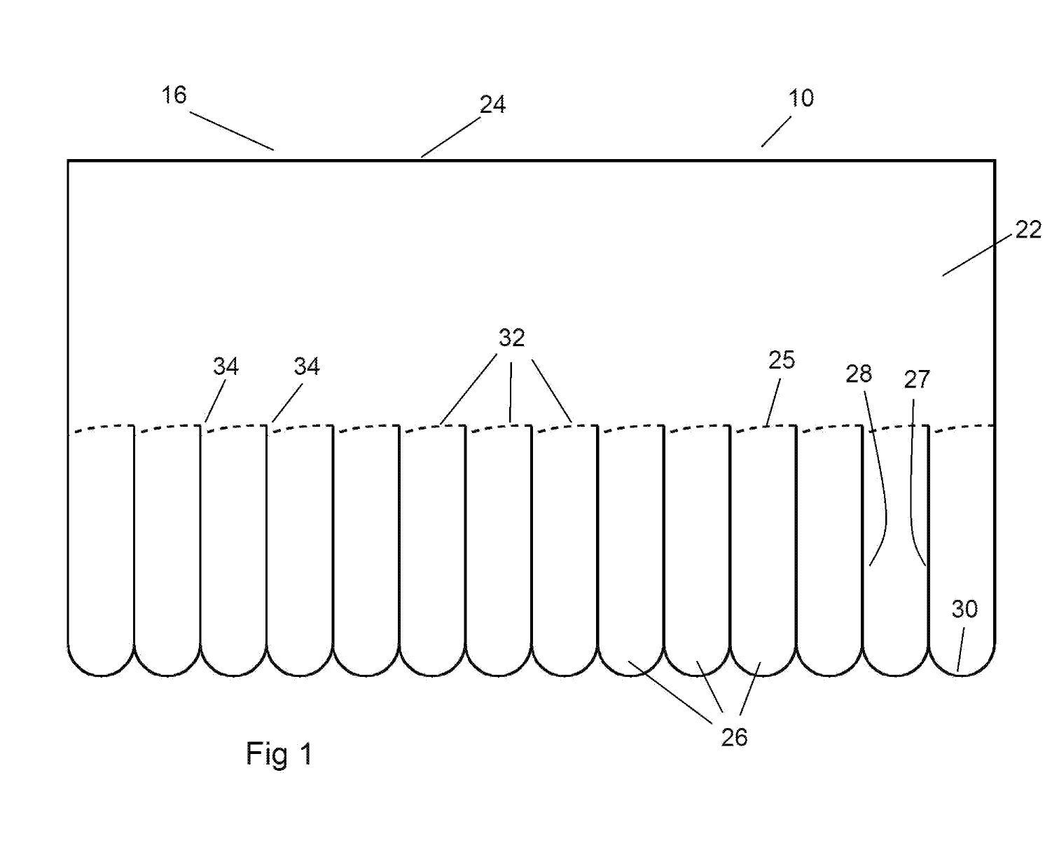

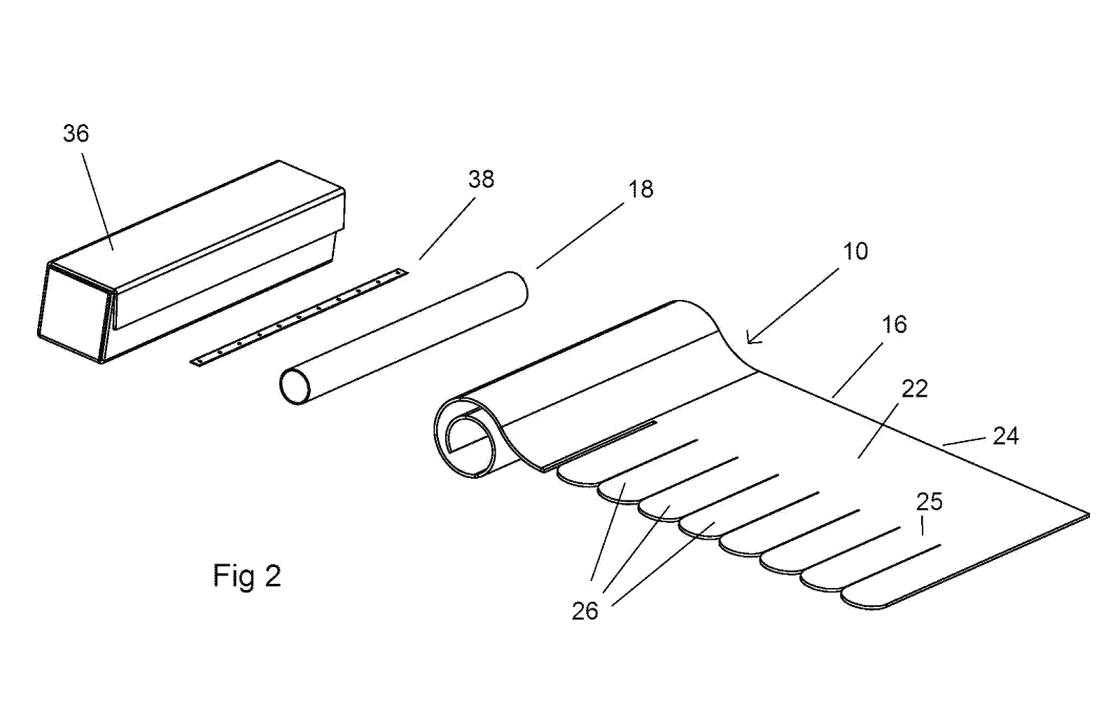

The sheet 16 is preferably provided on a roll 18 such that a length of the sheet 16 can be provided and transverse rectangular segments (as shown in FIG. 1) torn off as required.

The sheet 16, and each transverse segment formed by separation from the roll 18, includes a portion 22 adjacent a first longitudinal side of the sheet 16. The portion 22 comprises a continuous rectangular section of the sheet material having a first longitudinal side 24 and a second longitudinal side 25. The portion 22 is provided to cover in use the side wall 14 of the baking tin 12.

The tin liner 10 is provided with a plurality of elongate strips 26 extending generally transversely from the second longitudinal side 25 of the portion 22. The elongate strips 26 are provided to cover in use the base wall 15 of the baking tin 12 in which the tin liner 10 is to be used

In the embodiment shown, the elongate strips 26 each include first and second parallel longitudinal sides 27 and 28. The elongate strips 26 are also provided with rounded distal ends 30. Each longitudinal side 27 and 28 of each elongate strip 26 is located directly adjacent a longitudinal side 28 or 27 of the adjacent longitudinal elongate strip 26. It is expected that the elongate strips 26 are to be formed during manufacture by commencing with a sheet that has a width equal to the distance between the first longitudinal side 24 and the end of the elongate strips 26 and then creating a plurality of cuts along the side opposite the first longitudinal side 24 to separate the elongate strips 26. Each longitudinal elongate strip 26 therefore adjoins the adjacent elongate strips 26 with no gap between adjacent pairs of elongate strips 26.

The cutting process would be also used to form the rounded distal ends 30 by cutting portions from the edge of the original sheet.

In the embodiment shown, the length of the elongate strips 26 is approximately 45 to 50% of the width of the tin liner 10 from the first side 24 to the distal ends of the elongate strips 26. The length of the elongate strips 26 are preferably at least 40% of the width of the tin liner 10. Also, the width of the elongate strips 26 in the embodiment shown is approximately 25 to 30% of the length of the elongate strips 26. The width of the elongate strips 26 is preferably less than 40% of the length of the elongate strips 26. With these arrangements, the tin liner 10 is sized such that for standard baking tin 12 sizes, the portion 22 will cover the side wall 14 of the baking tin 12 with the elongate strips 26 being slightly longer than the radius of the base wall 15 so that the base wall 15 is covered in use.

The tin liner 10 is also provided with a plurality of creases 32 along the second longitudinal side 25. The creases 32 are provided adjacent the proximal end of each of the elongate strips 26. The creases 32 are provided to aid in the elongate strips 26 bending to a position transverse to the plane of the portion 22.

Each of the creases 32 extends across the elongate strip 26 in a direction that is at an angle to an axis perpendicular to the elongate strip 26. Each crease 32 extends from an inner end 34 of the first longitudinal side 27 of the elongate strip 26 to a point on the second longitudinal side 28 offset away from the inner end 34 of the opposite second longitudinal side 28 of the elongate strip 26. The creases 32 are provided to aid overlapping of the elongate strips 26 in a fan type manner in use, as will be described. In the embodiment shown, each crease 32 comprises an arcuate crease. In an alternative embodiment however, the creases 32 may be linear.

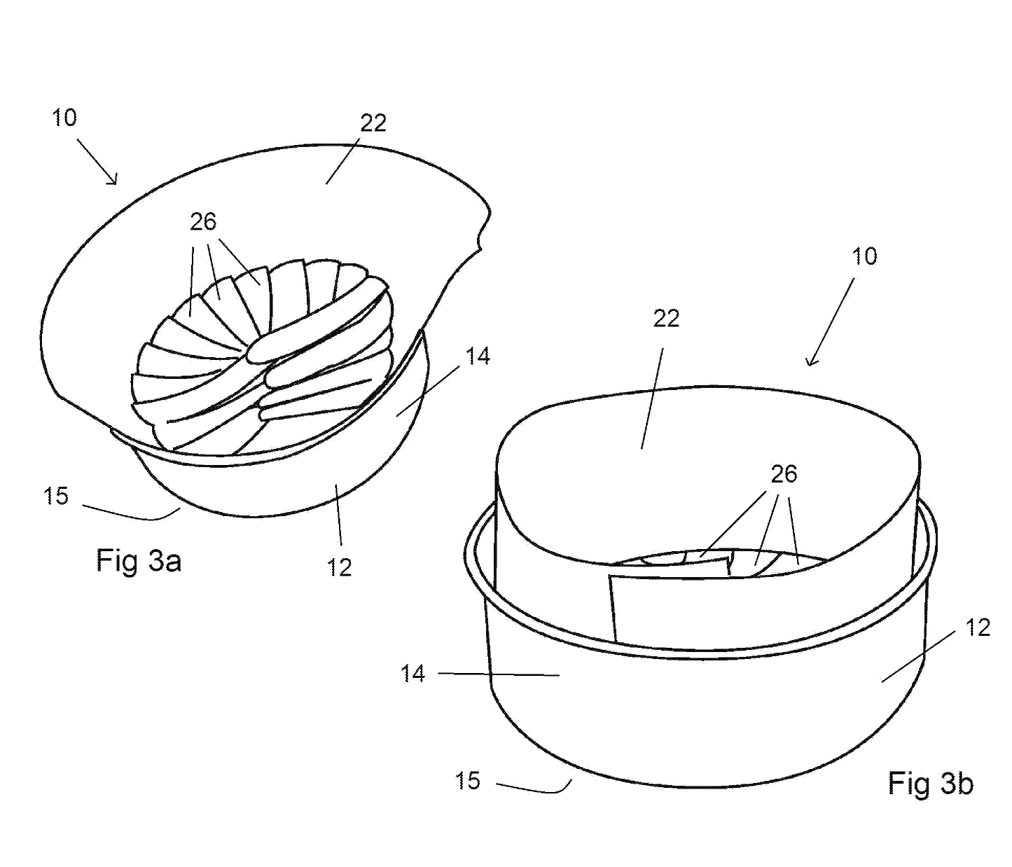

In use, a segment of the tin liner 10 is torn from the roll 18, such that the length is equal to or greater than the circumference of the baking tin 12. The portion 22 is formed into a tube as can be seen FIG. 3a while inserting the tin liner 10 into the baking tin 12 with the elongate strips 26 first.

The elongate strips 26 then bend along the creases 32 to become perpendicular to the plane of the formed tube. The angle of the creases 32 results in the elongate strip 26 on the first longitudinal side 27 being slightly above the second longitudinal side 28 of the adjacent elongate strip 26 in the bent position. In this way, the second longitudinal side 28 of each elongate strip 26 is received under the first longitudinal side 27 of the adjacent elongate strip 26 so that the elongate strips 26 all overlap in a fan type arrangement. The rounded distal ends 30 of the elongate strips 26 also aid in the overlapping process so that the ends of the elongate strips 26 slide past each other without catching.

In the case shown, the formed tube has a circular cross section for use with the circular baking tin 12. When used with a square or rectangular baking tin, the tube formed from the portion 22 when placed in the baking tin 12 will have a corresponding square or rectangular cross section.

The elongate strips 26 thereby line the base wall 15 of the baking tin 10. The overlap of the elongate strips 26 is sufficient such that when a mixture is inserted into the baking tin 12, the mixture presses downwardly on the overlapping elongate strips 26 creating a sufficient seal to prevent significant amounts of mixture leaking through the elongate strips 26. In this way, a single segment of the tin liner 10 can be used to quickly and effectively line the circular baking tin 12, without the need for a separate portion of material to line the bas wall 15.

When it is required to remove the baked cake from the baking tin 12, it can simply be lifted by the portion 22. The tin liner 10 can then be easily removed from the cake.

The tin liner 10 is preferably provided on the roll 18 within a dispenser. The dispenser comprises an elongate box 36 having an opening through which a sheet of the tin liner 10 can be pulled. The box 36 includes a serrated cutting elongate strip 38 of a known type for tearing off segments of the tin liner 10 for use.

The tin liner 10 may include graduations (not shown) along the length thereof. The graduations are provided to give an indication of the length of tin liner 10 that must be torn off for a particular size of baking tin 12. Perforated lines (not shown) may also be provided along the length of the tin liner 10 to allow sections to be torn off without the need for the cutting elongate strip 38.

It will be readily apparent to persons skilled in the relevant arts that various modifications and improvements may be made to the foregoing embodiments, in addition to those already described, without departing from the basic inventive concepts of the present invention.

1. A tin liner comprising:
a portion of sheet of material having a first longitudinal side and a second longitudinal side; and
a plurality of transversely extending elongate strips extending from the second longitudinal side, each elongate strip having first and second parallel longitudinal sides;
wherein when the sheet of material is formed into a tube, the elongate strips can be folded perpendicularly to the plane of the sheet such that the elongate strips overlap to form a planar surface bounding an end of the formed tube.

2. The tin liner in accordance with claim 1, wherein each elongate strip is provided with a crease extending across the elongate strip adjacent a proximal end in a direction that is at an angle to an axis perpendicular to the elongate strip.

3. The tin liner in accordance with claim 2, wherein each crease extends from an inner end of a first longitudinal side of the elongate strip to a point offset away from the inner end of an opposite second longitudinal side of the elongate strip.

4. The tin liner in accordance with claim 3, wherein the creases are arcuate in shape.

5. The tin liner in accordance with claim 1, wherein the elongate strips include rounded distal ends.

6. The tin liner in accordance with claim 1, wherein the length of the elongate strips is at least 40% of the width of the tin liner from the first side of the portion of the sheet material to the distal ends of the elongate strips.

7. The tin liner in accordance with claim 6, wherein the length of the elongate strips is 45 to 50% of the width of the tin liner.

8. The tin liner in accordance with claim 6, wherein the width of each elongate strip is less than 40% of the length of the elongate strip.

9. The tin liner in accordance with claim 8, wherein the width of each elongate strip is 25 to 30% of the length of the elongate strip.

10. The tin liner in accordance with claim 1, wherein each longitudinal elongate strip is directly adjacent each of the adjacent elongate strips so that no gap exists between adjacent pairs of elongate strips.

11. The tin liner in accordance with claim 1, wherein the tin liner is provided on a roll within a dispenser.

12. The tin liner in accordance with claim 11, wherein the dispenser comprises an elongate box having an opening through which a sheet of the tin liner can be pulled and a serrated cutting elongate strip for tearing off segments of the tin liner for use.

13. The tin liner in accordance with claim 1, wherein the tin liner includes graduations along the length thereof to provide an indication of the length of tin liner.

14. The tin liner in accordance with claim 1, wherein perforated lines are provided along the length of the tin liner to allow sections to be torn off.
